(19) United States
(12) Patent Application Publication
(10) Pub. No.: US 2010/0310361 A1
(43) Pub. Date: Dec. 9, 2010

(54) WIND TURBINE WITH TWO SUCCESSIVE PROPELLERS

(75) Inventor: Frederic Carre, Froges (FR)

Correspondence Address: OLIFF & BERRIDGE, PLC, P.O. BOX 320850, ALEXANDRIA, VA, 22320-4850, US

(73) Assignee: ELENA ENERGIE, Grenoble (FR)

(21) Appl. No.: 12/678,182

(22) PCT Filed: Oct. 10, 2008
(86) PCT No.: PCT/FR08/01425

§ 371 Date: Mar. 15, 2010

(30) Foreign Application Priority Data
Oct. 11, 2007 (FR) 07 07124

(51) Int. Cl. F03D 1/02; H02P 9/04; F03D 1/04

(52) U.S. Cl. 415/199.5; 290/44; 416/128

(57) ABSTRACT

A wind turbine comprises a tubular casing having an inlet opening, an outlet opening, an outer surface generating a pressure decrease, an inner surface presenting a convergent section joined to the inlet opening, a divergent section joined to the outlet opening and to the convergent section by a throat, and a propeller mounted rotating with respect to the tubular casing in proximity to the throat. It is coupled to a first generating machine. It comprises another propeller mounted rotating with respect to the tubular casing, placed upstream from the first propeller in the convergent section.

### BACKGROUND OF THE INVENTION

The invention relates to a wind turbine having a tubular casing comprising:
a circular air inlet opening,
a circular outlet opening,
an outer surface generating a pressure decrease, between the inlet opening and the outlet opening,
an inner surface delineating an air passage joining said openings, having a horizontal straight direction of flow and presenting a convergent section joined to the inlet opening and a divergent section joined to the outlet opening, said sections being joined to one another by a throat,
rotary means positioned axially in proximity to the throat and converting the air flow movement at the throat into a rotational movement of a coupling means connected to a first generating machine,
and a first propeller mounted rotating with respect to the tubular casing, upstream from the rotary means, placed axially in the convergent section of the inner surface.

### STATE OF THE ART

Such wind turbines are known for example from the documents JP2005240668 and JP2003028043, for which the inner surface has the general form of a nozzle. According to Bernoulli's equation, the inlet air is accelerated in the convergent section, this increase of the kinetic energy of the wind being accompanied by a progressive decrease of the pressure. The shape of the divergent section creates an additional pressure decrease which has the effect of performing suction, from the inlet to the outlet (“Venturi” effect). These known wind turbines present the shortcoming of only having an acceptable electric power production for a relatively high wind speed, and of having a relatively low general efficiency on account of the low value of the ratio between the power collected by the rotary device at the throat and the wind power at the throat.

It has further been imagined in the document EP1108888 to place two identical propellers in parallel manner at the ends of a cylindrical tubular casing and rotating in opposite directions of rotation. Each end of the tubular casing is extended by a conical shape, convergent on inlet and divergent on outlet. The action of channelling the air through such a structure of Venturi type (with an increase of the kinetic energy in the air) is accompanied by a pressure decrease in the convergent inlet part followed by a pressure drop when flowing through the inlet propeller. The latter has the effect of creating a pressure decrease to accelerate the air in the cylinder before reaching the output propeller. But the efficiency when the wind speed is low is limited and the performances are not satisfactory for a large number of applications. To feed the pressure decrease at the rear of the outlet opening in spite of a low wind speed, it is necessary to provide deflectors salient from the external surface near the outlet opening. But such deflectors then have the consequence of reducing the speed of the air on the outside, and therefore of reducing the general efficiency.

The document WO2006/054290 describes a wind turbine according to the preamble. It comprises a continuously-driving upstream propeller to provide energy to the fluid (either fan or compressor). The rotary means is a generating turbine providing mechanical energy, for example to an electric power generator. The upstream propeller is always in compressor mode to increase the Mach number of the air flow to Mach1 at the level of the throat upstream from the turbine. This condition is the basic principle used in this document to recover a part of the internal energy of the fluid in the pressure reduction that takes place in the turbine (going from Mach1 to Mach0 on outlet).

This document also provides for the case where two drive propellers are placed upstream from the turbine. As above, they act as compressors to increase the airflow to Mach1 at the throat. They are always energy consumers. The propeller fitted between the first propeller and the turbine requires less energy than the first propeller situated in the plane of the inlet opening and, without any wind, enables the first propeller to be started via the turbine by mechanical driving of a transmission shaft.

In all cases, the propeller or propellers placed upstream from the rotary means constituted solely by a turbine operates or operate in compressor mode whatever the natural wind speed. The external shape has no particular incidence on the operation of the wind turbine as, although it potentially generates a pressure reduction, the angle of convergence of the convergent section T2 is too great and causes the air flow slipping on the outer surface to separate, eliminating any influence of the external flow on the internal flow. The ratio between the diameter of the throat and the diameter of the inlet opening is substantially equal to 0.3. This very low ratio is a requirement to achieve a speed close to Mach1 at the throat, this speed condition, evocated in the document WO2006/054290, being the consequence of the use of a turbine for coupling to the electrical power generator, said turbine being designed to recover a part of the internal energy of the fluid by pressure reduction in the turbine.

### OBJECT OF THE INVENTION

The object of the invention consists in providing a wind turbine having an increased general efficiency.

The wind turbine according to the invention is remarkable in that:
the rotary means are formed by a second propeller mounted rotating with respect to the tubular casing and configured so as to rotate in the opposite direction to the first propeller,
the ratio between the diameter of the throat and the diameter of the inlet opening is comprised between 0.6 and 0.8,
an outer surface comprises a divergent section joined to the inlet opening and a convergent section joined to the outlet opening, the sections being shaped so as to form a surface of revolution the axis of revolution whereof coincides with the direction of flow and a generating curve whereof is formed by the upper surface of an airplane wing,
a reversible second generating machine to which the first propeller is connected, and which is connected to regulating means adjusting the operation of the first propeller according to at least one physical parameter related to the operation of the second propeller.

With respect to the wind turbine of the document WO2006/054290, the objective of the wind turbine according to the invention is not to recover the internal energy of the fluid, merely satisfying itself with considering the kinetic energy/pressure energy exchanges. This is why the rotary means arranged in proximity to the throat and coupled to the first generating machine are formed by a propeller that does not require a severe air speed condition to be able to operate. The speed at the throat is thus approximately equal to Mach 0.3 due to the fairly high ratio (comprised between 0.6 and 0.8) between the diameter of the throat and the diameter of the inlet opening. This ratio can be all the greater by using the outer surface in the form of an airplane wing profile which enables the air flow slipping on the outer surface to be greatly accelerated without the flow being separated due to a suitable convergence angle, and enabling a sufficient pressure decrease to be generated at the rear of the wind turbine to increase the fluid speed arising from the air passage. Unlike the prior art, operation of the first propeller is conditioned by a physical parameter linked to the second propeller placed at the throat, that is able to vary between operation as a fan and free operation to generate energy itself by coupling with a proper generator.

### BRIEF DESCRIPTION OF THE DRAWINGS

Other advantages and features will become more clearly apparent from the following description of particular embodiments of the given for non-restrictive example purposes only and represented in the appended drawings, in which:

FIG. 1 is an axial cross-sectional view of an example of a wind turbine according to the invention,

FIG. 2 is a left-hand side view of the wind turbine of FIG. 1,

FIG. 3 represents a control device of the wind turbine of the previous figures,

FIG. 4 is an identical view to FIG. 1, but giving details of the air flow.

### DESCRIPTION OF A PREFERRED EMBODIMENT OF THE INVENTION

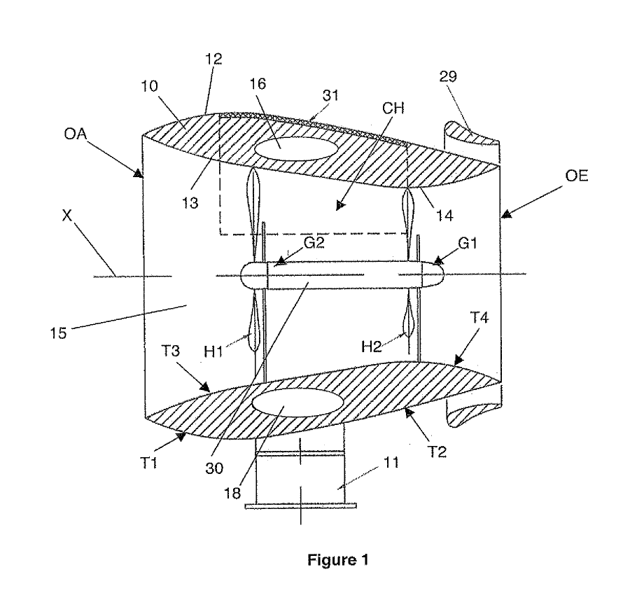

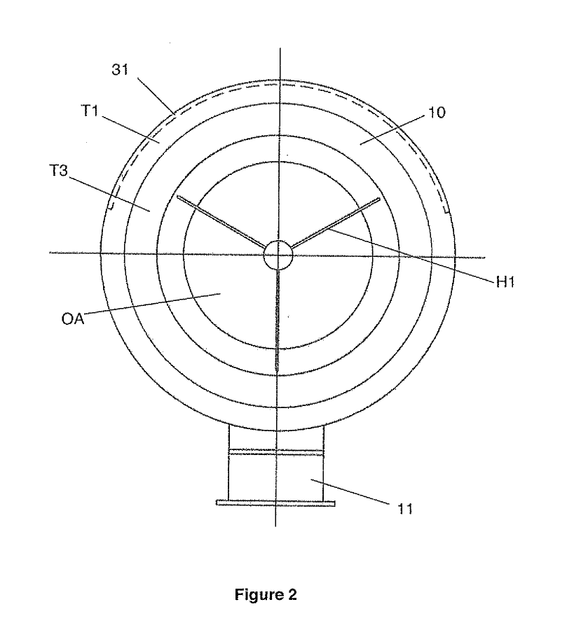

With reference to FIGS. 1 to 4, the example of a wind turbine according to the invention comprises a tubular casing 10 mounted with rotation along a vertical axis at the apex of a support structure 11. Tubular casing 10 presents a general revolution form and therefore has an axis of revolution which will correspond in the following to the air flow direction X, which is straight and horizontal. Orientation of tubular casing 10 with respect to support structure 11 is performed automatically, i.e. in free manner according to the direction of the wind, or by a directing mechanism ensuring that the air flow direction X is co-linear to the direction of the wind.

At one end (on the left in FIGS. 1, 3, 4), tubular casing 10 delineates an inlet opening OA of circular shape for inlet of air if there is any wind blowing. At the opposite end (the right in FIGS. 1, 3, 4), tubular casing 10 delineates an outlet opening OE of circular shape the diameter whereof can be slightly smaller than that of inlet opening OA (as is represented), or equal thereto or slightly larger. Outlet opening OE enables the air inlet via inlet opening OA to be outlet from tubular casing 10.

Tubular casing 10 comprises an external surface 12 presenting an aerodynamic profile in the form of an airplane wing, with a bulge constituting a divergent section T1 starting from inlet opening OA and along which the external diameter increases progressively, and a convergent section T2 joining section T1 and outlet opening OE and along which the external diameter decreases progressively. Such an aerodynamic profile has the effect of producing a pressure decrease at the level of outlet opening OE. Outer surface 12 therefore generates a pressure reduction between inlet opening OA and outlet opening OE.

More precisely, sections T1 and T2 are shaped such as to constitute a surface of revolution the axis of revolution whereof coincides with the air flow direction X and a generating curve whereof is formed by the upper surface of an airplane wing. The dimensional characteristics of the upper surface are able to be adjusted according to the expected natural speed of the wind (chord, camber, angle of attack, angle of convergence, angle of divergence, trailing angle etc).

Tubular casing 10 internally delineates an inner surface 13 presenting an aerodynamic profile in the form of a lower surface of wing, with a bulge constituting a convergent section T3 joined to inlet opening OA and along which the internal diameter decreases progressively, and a divergent section T4 joining convergent section T3 and outlet opening OE and along which the internal diameter increases progressively. The two sections T3 and T4 of inner surface 13 are joined to one another by a throat 14. Inner surface 13 delineates an air passage 15 in the form of a nozzle joining openings OA and OE to one another, and in which the air flows in the direction of air flow direction X from inlet opening OA until it is outlet via outlet opening OE. The ratio between the diameter of throat 14 and the diameter of inlet opening OA is comprised between 0.6 and 0.8. The ratio between the axial length of the wind turbine and the diameter of inlet opening OA is greater than 1.4, preferably comprised between 1.5 and 2.

The wind turbine comprises a first propeller H1 placed in convergent section T3 and rotary means placed in throat 14 and converting the air flow movement at throat 14 into a rotation movement of a shaft connected to a first generating machine G1. The rotary means are formed by a second propeller H2 mounted rotating with respect to tubular casing 10 in an axial position (along axis X) in proximity to throat 14. Second propeller H2 is connected to first generating machine G1 by means of a coupling means such as a fixed tube or a connecting shaft. The axis of rotation of propellers H2 and H1 coincides with the air flow direction X. First generating machine G1 is an electrodynamic machine generating electric power when its rotor is animated with a rotation movement with respect to its stator.

Furthermore, first propeller H1 is mounted rotating with respect to tubular casing 10 upstream from second propeller H2, in an axial position (along axis X) along convergent section T3 of inner surface 13. First propeller H1 is connected to a second generating machine G2 of reversible type. More precisely, second generating machine G2 is a reversible electrodynamic machine. The diameter of propeller H1 is larger than that of propeller H2. With inner surface 13 and propeller H2, it delineates a compression and acceleration chamber CH of the air that is inlet via inlet opening OA. The air undergoes an increase of its kinetic energy in chamber CH.

Propellers H2 and H1 both comprise a plurality of blades arranged angularly with a variable pitch. Propeller H2 is further configured so as to rotate in the reverse direction from propeller H1.

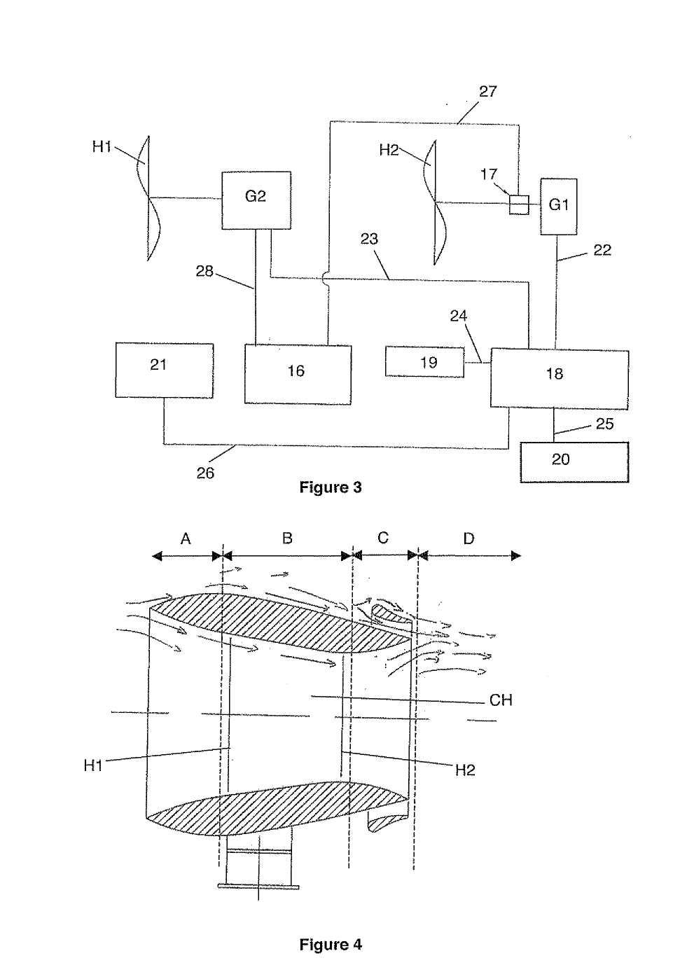

In addition to tubular casing 10, two propellers H1, H2 and generating machines G1, G2, the wind turbine comprises an electronic control device (see FIG. 3) comprising:
regulating means 16 of reversible second generating machine G2, for example integrated in the thickness of tubular casing 10,
a sensor 17 measuring a physical parameter associated with operation of second propeller H2,
an energy management system 18, for example integrated in the thickness of tubular casing 10, and connected to energy storage means 19 and/or to electric power grid 20 and to external electric power supply means 21.

The two generating machines G1 and G2 are electrically connected to energy management system 18 respectively by means of connections referenced 22 and 23. Energy management system 18 is electrically connected to energy storage means 19 by a connection 24 and/or to electric power grid 20 by a connection 25 and to external electric power supply means 21 by a connection 26. Finally, regulating means 16 of second generating machine G2 are electrically connected to sensor 17 by a connection 27 and to second generating machine G2 by a connection 28.

Second generating machine G2 being reversible, it can be driving when it is supplied with electricity, its rotor then being made to rotate with respect to its stator by means of the power input provided. Machine G2 can also operate as a generator: it generates electric power when propeller H1 imposes a rotational movement on rotor of machine G2 with respect to its stator.

Furthermore, a reversible coupling system, not represented (for example a centrifugal or electromagnetic clutch or by electric control of the motor/generator of machine G2) is interposed between propeller H1 and second generating machine G2 to be able to ensure that propeller H1 is mounted rotating freely in case of uncoupling. Connection 28 performs linking between the coupling system and regulating means 16.

When propeller H1 is disconnected from generating machine G2, propeller H1 is in “freewheel” mode. In the opposite case, it is either in “motor” mode (corresponding to operation of generating machine G2 as a motor) or in “generator” mode (corresponding to operation of generating machine G2 as a generator).

The role of regulating means 16 is to select the operating mode of first propeller H1 (“motor”, “generator”, or “freewheel”) that is suitable at each moment. Selection of the operating mode of propeller H1, at each moment, enables operation of first propeller H1 to be adjusted according to at least one physical parameter (pressure, speed, temperature, etc) measured by sensor 17 and linked to operation of second propeller H2. Selecting the operating mode of first propeller H1 is performed by a corresponding action on second generating machine G2 and on the coupling system via connection 28.

For example, by selection matching the operating mode of propeller H1 at each moment, regulating means 16 can perform modulation of the speed of rotation of first propeller H1 according to the speed of rotation of second propeller H2 measured by sensor 17 when the latter is a tachometer. In steady operating conditions, this type of modulation in particular enables rotation of the air in passage 15 to be prevented or at least controlled.

For example purposes, to perform such a speed modulation of first propeller H1, regulating means 16 integrate a first control law imposing on first propeller H1:
“motor” mode so long as the speed of rotation of second propeller H2 is lower than a preset first threshold Ω1,
“generator” mode when the speed of rotation of second propeller H2 is higher than a preset second threshold Ω2 that is higher than Ω1,
“freewheel” mode when the speed of rotation of second propeller H2 is comprised between Ω1 and Ω2.

Regulating means 16 can also integrate a second control law that takes priority over the first control law and imposes “motor” mode on first propeller H1 as soon as the difference between the speed of rotation of second propeller H2 and the speed of rotation of first propeller H1 is greater than a preset third threshold Ω3, which can itself be a function of Ω1.

Selection of the operating mode of first propeller H1 is performed by regulating means 16 via connection 28 from information received from sensor 17 via connection 27.

Whatever the operating mode imposed on first propeller H1 by regulating means 16, energy management system 18 receives the electric power created by first generating machine G1 via connection 22. When regulating means 16 impose “motor” mode on first propeller H1, energy management system 18 transmits the necessary electric power to second generating machine G2 via connection 23. When regulating means 16 impose “generator” mode on first propeller H1, energy management system 18 receives the electric power produced by second generating machine G2 via connection 23. Finally, when regulating means 16 impose “freewheel” mode on first propeller H1, energy management system 18 and second generating machine G2 do not exchange electric power.

In parallel to these power exchanges with the two generating machines G1, G2, produced energy management system 18:
transmits the energy received from first generating machine G1 (and if applicable from second generating machine G2 in case of “generator” mode of first propeller H1) to electric power grid 20 via connection 25 and/or to energy storage means 19 via connection 24,
and if applicable, in case of “motor” mode of first propeller H1, receives the energy necessary for driving second generating machine G2 from electric power grid 20 via 25 and/or from energy storage means 19 via connection 24 and/or from external electric power supply means 21 via connection 26.

To perform these operations, energy management system 18 comprises an interface between the signals exchanged with generating machines G1, G2 and the signals exchanged with electric power grid 20, energy storage means 19 and external electric power supply means 21. Such an interface can for example comprise transformers, frequency convertors and rectifiers.

The parameters involved in the strategy carried out by energy management system 18 in so far as how it orders its exchanges with the other components of the control device and with the two generating machines G1, G2 is concerned, can be adjusted according to the applications. In particular, transmission to electric power grid 20 can be favored in certain applications. In other cases, the energy level in storage means 19 and/or consumption peak management will be preferred.

With reference to FIG. 4, the wind turbine can be fictitiously broken down into three successive zones A, B, C staggered in the direction of air flow axis X and in the direction of the airstream passage. The rear part of the wind turbine, beyond outlet opening OE, constitutes an additional zone D. Zone A of the wind turbine corresponds to the part of the wind turbine situated between the plane passing via inlet opening OA and the plane passing via the end of divergent section T1 of outer surface 12. Zone B of the wind turbine corresponds to the part of the wind turbine comprised between zone A and the plane passing via the end of convergent section T3 of inner surface 13. Zone C of the wind turbine is for its part formed by the part of the wind turbine comprised between zone B and the plane passing via outlet opening OE. As illustrated in FIG. 4, compression and acceleration chamber CH is included in zone B of the wind turbine.

In zone A, whatever the operating mode of first propeller H1, the flux of the airstream flowing in passage 15 is accelerated with respect to the wind in which the wind turbine is placed. The flux of the airstream slipping on outer surface 12 is also accelerated with respect to the wind, but by a lower value than the acceleration undergone by the air in passage 15.

In zone B, the external diameter decreases progressively, which has the effect of creating a pressure decrease and therefore an acceleration of the flux of the airstream slipping on outer surface 12. The flux of the airstream in passage 15 is also accelerated over the whole length of zone B on account of the convergent nature of section T3. These internal and external accelerations take place whatever the operating mode in first propeller H1. The flux of the airstream in passage 15, in parallel to its acceleration, undergoes a continuous and progressive pressure increase over the whole length of zone B. The pressure increase is greater in chamber CH than over the rest of zone B, all the more so when propeller H1 is operating in “motor” mode.

In zone C, the flux of the airstream slipping on outer surface 12 continues to accelerate. The internal diameter increases progressively up to outlet opening OE which has the effect of creating an additional pressure decrease.

In zone D, the air outlet via outlet opening OE is accelerated by the flux of the airstream slipping on outer surface 12, which has a higher speed. This results in creation of an additional pressure decrease at the rear of the wind turbine and in rejection of the aerodynamic disturbances to the rear of the wind turbine. The pressure decrease generated in zone D contributes to maintaining the process described above. This global aerodynamic action enables the air flow at the inlet of the wind turbine to be accelerated.

Photovoltaic cells 31 can be provided on all or part of outer surface 12 to constitute external electric power supply means 21. However these means can be achieved by any suitable solution such as a hydraulic power source or an auxiliary generator.

Generating machines G1, G2 can be compact and located on air flow direction X. In other alternative embodiments, generating machines G1, G2 can be arranged in a crown, i.e. the associated propellers H1, H2 themselves constitute the rotors of generating machines G1, G2 and the stator is constituted by a peripheral crown supported in facing manner by inner surface 13.

Optionally and as represented, it is possible to provide an axially-extending aerodynamic shield 30, for example having a cylindrical external shape, between propellers H1, H2 to prevent aerodynamic disturbances in proximity to air flow direction X. It is clear that such an aerodynamic shield 30 has to maintain mechanical disconnection of propellers H1, H2. Furthermore, it is possible to envisage housing second generating machine G2 inside the aerodynamic shield.

In the example described above, air flow direction X is horizontal. Tubular casing 10 comprises a pressure-reducing aerodynamic appendix 29 salient from outer surface 12 in proximity to outlet opening OE. This appendix 29 enables the acceleration undergone by the flux of the airstream slipping on convergent section T2 of outer surface 12 to be accentuated, and considerably attenuates the noise produced by the air flow on outer surface 12. The “parachute” effect (occurrence of turbulences on outlet from tubular casing 10) occurs for wind speeds that are substantially greater than in the case where no appendix 29 is present. The aerodynamic shield further performs a centrifugal deviation of the air flow with respect to direction X, further increasing the pressure reduction at the rear of the wind turbine. In other words, it generates a divergence of the air flow slipping on outer surface 12 and a reduction of the air pressure at the rear of the wind turbine.

Aerodynamic appendix 29 has the form of a crown maintained at a distance around tubular casing 10 and having an inner surface facing outer surface 12, and an opposite outer surface. In a cross-sectional plane passing via air flow axis X, the inner surface of the crown has a convex aerodynamic profile with a bulge directed towards outer surface 12, whereas outer surface of the crown presents a concave aerodynamic profile with a hollow directed towards outer surface 12. The ratio between the diameter of aerodynamic appendix 29 and the diameter of inlet opening OA is less than 1.3 to limit the overall dimensions of the wind turbine.

A mechanical brake can be provided associated with propellers H1, H2. Furthermore, the control device described in the foregoing can include functions for providing economic and energy balances and maintenance forecasts.

Finally, several wind turbines according to the invention can be grouped in horizontal cascades on a circular axis and/or on different axes and planes. To identify each of the wind turbines, a radiofrequency device can be associated with each wind turbine.

To sum up, the wind turbine according to the invention does not use the internal energy of the air flowing through passage 15. Whatever the operation, the air flow as a whole remains lower than Mach 0.3. Mainly, only the kinetic energy/pressure energy exchanges are considered, in practice ignoring the variations of internal energy of the fluid.

Propeller H1 serves the purpose of accelerating the flow in motor mode, for light winds only. This operation triggers start-up of propeller H2 and enables operation to take place more efficiently with light winds. Indeed, in this operating range, as the flowrate is higher, second propeller H2 has a substantially better efficiency. This type of operation is imposed so long as the sum of the energies supplied by propeller H1 and consumed by propeller H2 is greater than the sum of the energies supplied by the two propellers both operating as generators.

Convergence of the internal flow is used to increase the axial speed of the flow without substantially increasing the air density: the higher speed at the throat means that a faster propeller H2 can be used, with a better efficiency. In operation as a generator, propeller H1 uses the energy of the wind linked to the axial component of the speed and restores a speed having a rotational component (Euler's relation). This rotational component is recovered by propeller H2 which restores a purely axial flow on outlet of the unit. Without propeller H1, the speed of flow on outlet from propeller H2 would necessarily have a rotational component (Euler's relation). The corresponding kinetic energy would then be lost. Globally contra-rotating propellers H1, H2 have a better efficiency than a single propeller H2, in spite of the greater friction losses.

The shape of outer surface 12, the shape of inner surface 13, the choice of taking a propeller constituting the rotary means at the throat, and the choice of a throat with a relatively low constriction, are choices made to bring the point of attack as close as possible to inlet opening OA, unlike the prior art.

1.-7. (canceled)

8. A wind turbine having a tubular casing comprising:
a circular air inlet opening,
a circular outlet opening,
an outer surface generating a pressure decrease, between the inlet opening and the outlet opening,
an inner surface delineating an air passage joining said openings, having a horizontal straight direction of flow and presenting a convergent section joined to the inlet opening and a divergent section joined to the outlet opening, said sections being joined to one another by a throat,
rotary means positioned axially in proximity to the throat and converting the air flow movement at the throat into a rotational movement of a coupling means connected to a first generating machine,
and a first propeller mounted rotating with respect to the tubular casing, upstream from the rotary means, placed axially in the convergent section of the inner surface, wherein:
the rotary means are formed by a second propeller mounted rotating with respect to the tubular casing and configured so as to rotate in the opposite direction to the first propeller,
the ratio between the diameter of the throat and the diameter of the inlet opening is comprised between 0.6 and 0.8,
the outer surface comprises a divergent section joined to the inlet opening and a convergent section joined to the outlet opening, the sections being shaped so as to form a surface of revolution the axis of revolution whereof coincides with the direction of flow and a generating curve whereof is formed by the upper surface of an airplane wing,
a reversible second generating machine to which the first propeller is connected, and which is connected to regulating means adjusting the operation of the first propeller according to at least one physical parameter related to the operation of the second propeller.

9. Wind turbine according to claim 8, wherein the tubular casing comprises a pressure-reducing aerodynamic appendix salient from the outer surface in proximity to the outlet opening, generating a divergence of the air flow slipping on the outer surface and an air pressure decrease at the rear of the wind turbine.

10. Wind turbine according to claim 8, wherein the regulating means perform modulation of the speed of rotation of the first propeller according to the speed of rotation of the second propeller.

11. Wind turbine according to claim 8, wherein the first and second generating machines are connected to an energy management system connected to energy storage means and/or to the electric power grid.

12. Wind turbine according to claim 11, wherein the energy management system is connected to external power supply means.

13. Wind turbine according to claim 8, wherein an aerodynamic shield extends axially between the first and second propellers.

14. Wind turbine according to claim 8, wherein the ratio between the diameter of the aerodynamic appendix and the diameter of the inlet opening is less than 1.3.
